(19) United States
(12) Patent Application Publication
(10) Pub. No.: US 2010/0014748 A1
(43) Pub. Date: Jan. 21, 2010

(54) METHOD AND APPARATUS FOR REAL TIME FAULT DETECTION IN HIGH SPEED SEMICONDUCTOR PROCESSES

(75) Inventors: Mark L. Reath, Red Hook, NY (US); Justin W. Wong, South Burlington, VT (US); Steven Catlett, Poughkeepsie, NY (US); Michael L. Passow, West Hurley, NY (US); Harry R. Kolar, Scottsdale, AZ (US)

Correspondence Address: SCULLY, SCOTT, MURPHY & PRESSER, P.C., 400 GARDEN CITY PLAZA, Suite 300, GARDEN CITY, NY, 11530, US

(73) Assignee: International Business Machines Corporation, Armonk, NY (US)

(21) Appl. No.: 12/176,829

(22) Filed: Jul. 21, 2008

(51) Int. Cl. G06K 9/00

(52) U.S. Cl. 382/149

(57) ABSTRACT

An apparatus for collecting data during processing of a structure, such as a semiconductor wafer, which includes data collection devices or sensors positioned in a processing chamber for processing the wafer. The data collection sensors may operate at speeds of about 10 Hertz (Hz). A controller communicates and receives data from the data collection sensors. A data processing device communicates with the controller for receiving and processing the data, and the data processing device analyzes the data and determines at least one process response.

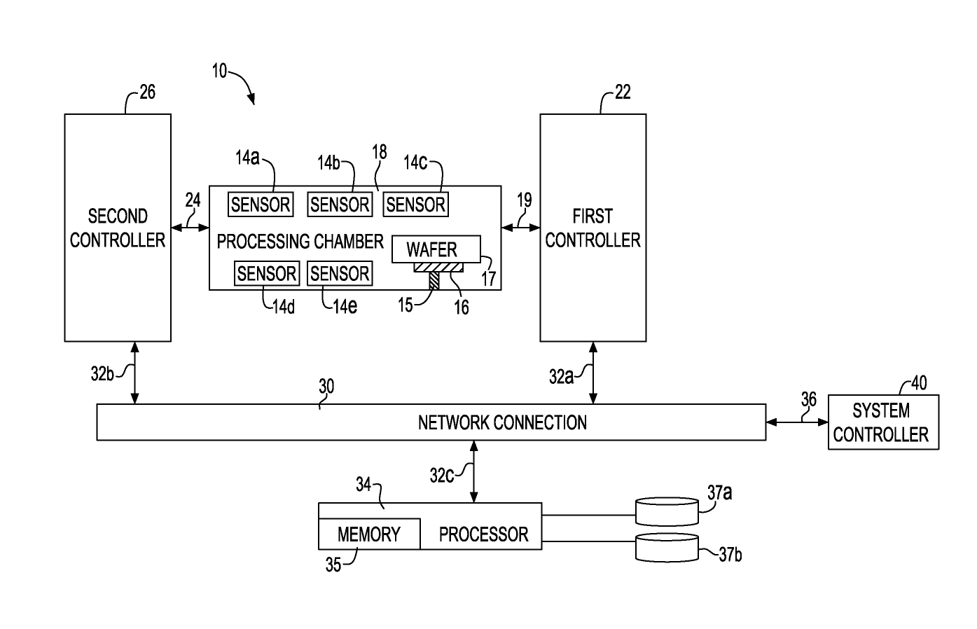

### FIELD OF THE INVENTION

The present invention relates to an apparatus for collecting data during processing of a structure, and more specifically, high speed data collection during processing of an electronic device in a processing chamber.

### BACKGROUND OF THE INVENTION

Typical semiconductor wafer manufacturing utilizes high speed single wafer reactors or process chambers for deposition, etch, and thermal processing. These reactors expose the wafer to temperature, pressure, flow rate and plasma transients that are currently inadequately monitored by conventional data collection devices, which may operate at about 1 Hertz (Hz), and current fault detection and classification (FDC) systems. Thus, there is a lack of monitoring of the performance of equipment within the process chamber, and the status or condition of the wafer during high speed processing within the process chamber.

Therefore, a need exists to improve monitoring during processing of an electronic device, e.g., a semiconductor, in a process chamber. Additionally, improved data collection during the process is needed to determine appropriate action during the process, which may include corrective action or termination of the process.

### SUMMARY OF THE INVENTION

In an aspect of the invention an apparatus for collecting data during processing of a structure includes at least one data collection device positioned in a process chamber wherein the data collection device operates at speeds between about 10 Hertz (Hz) to 1000 Hz. A structure is positioned in the process chamber for processing, and at least one controller communicating and receiving data from the data collection device. A data processing device communicates with the at least one controller for receiving and processing the data, and the data processing device analyzes the data and determines at least one process response. In one embodiment, the structure is an electronic device. In another embodiment, the processing chamber is a semiconductor processing chamber for processing a semiconductor device. The data collection device may operate at speeds of at least 10 Hz, or may operate at speeds between 10 Hz and 1 kHz. In another embodiment the apparatus may further include a plurality of sensors as data collection devices. The apparatus may further include a plurality of data collection devices including data buffering and servo-loop controller subsystems, and may also include a plurality of controllers for parallel data collection. In another embodiment, the data collection device may be coupled to a tool for processing a semiconductor element in a process chamber. The semiconductor element may be a semiconductor wafer, and in another embodiment, the tool may be a wafer accessor arm for moving the wafer within the process chamber. Further, the tool may be a robotic arm for moving a photolithographic reticle within a lithography process tool. In another embodiment, the at least one data collection device may be fixedly positioned in the process housing. The data processing device may include a computer and computer accessible memory, and the computer accessible memory may include flash memory, or DRAM memory. Further, the processing device may include a database.

In a related aspect, the processing of the data by the data processing device includes comparing the data to stored data models of process chambers in a memory device connected to the data processing device. In another embodiment, the data processing device receives and processes the data, and the apparatus further includes: a system controller communicating with the data processing device for receiving and analyzing the data and determining at least one process response for at least one process controlled by the system controller. Further, the system controller may processes the data received from the data processing device and compare the data to models of process chamber specifications stored in a memory device connected to the system controller to determine the at least one process response for the one or more processes controlled by the system controller.

### BRIEF DESCRIPTION OF THE DRAWING

These and other objects, features and advantages of the present invention will become apparent from the following detailed description of illustrative embodiments thereof, which is to be read in connection with the accompanying drawing, in which:

The FIGURE is a block diagram according to an embodiment of the invention depicting an apparatus for processing an electronic device in a process chamber connected to a controller, and a data processor and a system controller connected via a network connection.

### DETAILED DESCRIPTION OF THE INVENTION

In an illustrative embodiment according to the present invention, referring to the FIGURE, an apparatus 10 for collecting data during processing of a device, which may include an electronic device embodied as a semiconductor device such as a semiconductor wafer 17. The wafer 17 shown in the FIGURE, is positioned on a platform 16 and moving support 15. The apparatus 10 includes data collection devices embodied as a plurality of data collection sensors 14a-14e positioned in a processing chamber embodied as a semiconductor processing chamber 18 for measuring specified conditions within the chamber 18. Sensor measurements or data from the sensors 14a-14e is communicated to a first controller 22 via a communications link 19, and a second controller 26 via a communications link 24, wherein the communications links 19, 24 may include wireless or wired connections. The data is communicated to a data processor 34 via communications links 32a and 32b and 32c using a network connection 30, however, other connections may be use, such as one or more direct links. The data collection sensors 14a-14e are intended to include sensor capable of high speed data collection rates, including rates of many time per second, for example, 10-20 times per second, or 10 Hz (Hertz) or greater (where Hz is defined as a unit of frequency equal to one cycle per second), or 10 Hz to 1000 Hz (or 1 kHz). Thus, the high speed data collection sensors 14a-14e can measure sub-second process transients or variations in the process or wafer 17. In a further embodiment of the invention, a plurality of data collection devices may include data buffering and servo-loop controller subsystems (which is a type of servomechanism, or servo that is an automatic device which uses error-sensing feedback to correct the performance of a mechanism).

The plurality of sensors 14a-14e include, for example, a pressure sensor 14a, a radio frequency (RF) power sensor 14b, a direct current (DC) power sensor 14c, a temperature sensor 14d, and a lamp power sensor 14e. The pressure sensor 14a monitors and communicates the current pressure in the chamber 18. The RF power sensor 14b monitors and communicates the RF power within the chamber to ensure that RF transmissions are being transmitted at a specified strength from the chamber 18. The DC power sensor 14c monitors and communicates the DC power levels in the chamber required for processing the semiconductor. The temperature sensor 14d monitors and communicates the temperature in the chamber 18. The lamp power sensor 14e monitors and communicates the lamp power from lamps in the chamber which are used to heat the semiconductor wafer 17 during processing in the chamber 18.

In an alternative embodiment, the data collection devices may be included in, for example, accessors (tools within the process chamber), accessor arms or wafer accessor arms, robot accessors or robotic arms, or included in an accessor controller, or a wafer transport apparatus all inside the process chamber 18 and further including single wafer delivery systems, and wafer/reticle positioning systems used in photolithography. In an alternative embodiment of the invention, a tool is embodied as an accessor for moving a photolithographic reticle within a lithography process tool. Photolithography is a process used in semiconductor fabrication which may be use to selectively remove parts of a thin film using light to transfer a geometric pattern from a photomask or reticle to a light sensitive chemical or photoresist. The accessors facilitate locomotion of a wafer in the process chamber and may include using grippers or other characteristics for physically moving wafers. In this way, the data collection device included in the accessors are also moved within the process chamber 18 and collect data at different locations. However, in the embodiment of the invention referred to in the FIGURE, the data collection devices are fixed within the process chamber 18 and the wafer 17 is moved via support 15.

Outside the process chamber 18, first and second controllers 22, 26 communicate in parallel with the data collection sensors 14a-14e via communication links 19, 24, respectively, to provide analog to digital conversion of the data received from the sensors 14a-14e. The first controller 22 is the main controller with the second controller 26 providing additional capacity for data processing. The sensors 14a-14e and first and second controllers 22, 26, respectively, operate at speeds of at least 10 hz and may operate, for example, at speeds between 10 Hz and 100 Hz. The first and second controller 22, 26, respectively, include processors for receiving commands comprising, for example, manufacturing specifications. The controllers 22, 26 may convert the commands to physical movements of an accessor(s), and transmits signals for operating servo motors, thereby directing the operation of the accessor(s). The controllers 22, 26 may be dedicated to a particular accessor, or they may direct or control more than one accessor.

The controllers 22, 26 communicate via links 32a, 32b, respectively, with a data processor 34 using a network connection 30 and communication link 32c. The network 30 may include, for example, an Ethernet network, wired or wireless network. The data processor 34 receives and collects the data from the controllers 22, 26 and processes the data. The data processing may include for example, comparing the data with a predetermined model of managing the chamber 18, or a comparing the data with a plurality of models of chamber 18 specifications. The data processor 34 includes computer memory 35 which may include, for example, flash memory, or DRAM memory. The data processor 34 may further access one or more databases 37a and 37b for collecting and storing data, and, for example, conducting a modeling analysis where the data bases 37a, 37b are used to store data for extrapolation to determine a best response to a processing condition. Thus, the data processor 34 may access process chamber models stored in the memory device 35 or data bases 37a, 37b, or buffered memory (not shown) for comparing the data to models of process chamber specifications stored therein.

A system controller 40 communicates with the data processor 34 via the network 30 and a communications link 36. The system controller 40 receives the data from the data processor 34 and analyzes the data to determine anomalies in the data and if specified conditions are not being met in the process chamber 18. The system controller 40 may be a system wide controller for managing a plurality of processes each having one or more data processors, of which only one is shown in the embodiment of the FIGURE. A possible response to the data received may include, for example, stopping the processing of a microprocessor because conditions such as pressure, RF power, DC power, temperature, or lamp power are not within specifications. The system controller 40 may include, for example, a manufacturing business process control system which may include one or more computer and software programs. The present invention thus enables high speed, continuous real time data collection and processing to deliver near-instantaneous detection of processing conditions and process faults for high speed wafer processing. Consequently, appropriate corrective actions can be taken when process conditions are outside specifications. In an alternative embodiment, the data processor 34 and the system controller 40 may be combined into one system for both data processing and analyzing data for possible semiconductor processing responses of one or multiple processes in multiple process chambers.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. An apparatus for collecting data during processing of a structure, comprising:
at least one data collection device positioned in a process chamber wherein the data collection device operates at speeds between about 10 Hertz (Hz) to 1000 Hz;
a structure positioned in the process chamber for processing;
at least one controller communicating and receiving data from the data collection device; and
a data processing device communicating with the at least one controller for receiving and processing the data, and the data processing device analyzing the data and determining at least one process response.

2. The apparatus of claim 1, wherein the structure is an electronic device.

3. The apparatus of claim 2, wherein the processing chamber is a semiconductor processing chamber for processing a semiconductor device.

4. The apparatus of claim 1, wherein the data collection device operates at speeds of at least 10 Hz.

5. The apparatus of claim 1, wherein the data collection device operates at speeds between 10 Hz and 1 kHz.

6. The apparatus of claim 1, further including a plurality of sensors as data collection devices.

7. The apparatus of claim 1, further including a plurality of data collection devices including data buffering and servo-loop controller subsystems.

8. The apparatus of claim 1, further including a plurality of controllers for parallel data collection.

9. The apparatus of claim 1, wherein the data collection device is coupled to a tool for processing a semiconductor element in a process chamber.

10. The apparatus of claim 9, wherein the semiconductor element is a semiconductor wafer.

11. The apparatus of claim 10, wherein the tool is a wafer accessor arm for moving the wafer within the process chamber.

12. The apparatus of claim 11, wherein the tool is a robotic arm for moving a photolithographic reticle within a lithography process tool

13. The apparatus of claim 1, wherein the at least one data collection device is fixedly positioned in the process housing.

14. The apparatus of claim 1, wherein the data processing device includes a computer and computer accessible memory.

15. The apparatus of claim 14, wherein the computer accessible memory includes flash memory.

16. The apparatus of claim 14, wherein the computer accessible memory includes DRAM memory.

17. The apparatus of claim 14, wherein the processing device includes a database.

18. The apparatus of claim 14, wherein the processing of the data by the data processing device includes comparing the data to stored data models of process chambers in a memory device connected to the data processing device.

19. The apparatus of claim 14, wherein the data processing device receives and processes the data, and the apparatus farther includes:
a system controller communicating with the data processing device for receiving and analyzing the data and determining at least one process response for at least one process controlled by the system controller.

20. The apparatus of claim 19, wherein the system controller processes the data received from the data processing device and compares the data to models of process chamber specifications stored in a memory device connected to the system controller to determine the at least one process response for the one or more processes controlled by the system controller.
